(19) United States
(12) Patent Application Publication
(10) Pub. No.: US 2006/0212509 A1
(43) Pub. Date: Sep. 21, 2006

(54) Profile driven method for enabling annotation of World Wide Web resources

(75) Inventors: Lee Feigenbaum, Brookline, MA (US); Sean J. Martin, Boston, MA (US); Simon L. Martin, Hampshire (GB); Elias Torres, Lowell, MA (US)

Correspondence Address: John E. Campbell;IBM Corporation, 2455 South Road, P386, Poughkeepsie, NY, 12601, US

(73) Assignee: International Business Machines Corporation, Armonk, NY (US)

(21) Appl. No.: 11/085,405

(22) Filed: Mar. 21, 2005

(51) Int. Cl. G06F 15/16

(52) U.S. Cl. 709/201

(57) ABSTRACT

Disclosed are a client server annotation system for, and a method of, managing annotations for Web pages. The preferred client server annotation system comprises an annotation server for storing annotations; a set of Web page profiles, each of the page profiles being associated with one of the Web pages; and a client system including a client computer system. The client computer system includes instructions to execute a method comprising accessing Web pages, sending requests to the annotation server, locating at least one Web page profile, and using the located Web page profile to retrieve or store annotation information, from or to the annotation server, about the Web page associated with the Web page profile.

### BACKGROUND OF THE INVENTION

1. Field of the Invention

This invention generally relates to managing annotations for Web pages. More specifically, the invention provides a generalized profile mechanism that allows customized management of web page annotations.

2. Background Art

Annotation is the process of associating descriptive information with specific objects or parts of objects, usually without modifying the objects themselves. The World Wide Web is an extremely large and heterogeneous collection of objects that are potential targets of annotation. The disparate nature of these resources makes a single strategy for identifying and annotating them infeasible.

Finding a single way to consistently identify web pages and points within web pages to which an annotation refers is impossible. Additionally, because web pages' locations are completely decentralized, there is never an option of embedding annotations within the pages themselves. In addition, no single system will adequately display annotations on all web pages when page layout, colorization, language, etc. are considered. Current solutions to annotating World Wide Web pages do not separate the concept of a web page from that of the specific web resource that is being annotated. These systems would not allow, for example, an auction search-results page to show annotations on individual auction items. Furthermore, while there are some existing systems that allow web page authors to customize the annotation appearance and functionality for their web pages, such systems do not work for web pages whose authors have not modified their pages to fit the system.

### SUMMARY OF THE INVENTION

An object of this invention is to provide an improved procedure for managing annotations for Web pages.

Another object of the invention is to provide a generalized profile mechanism that allows customized management of Web page annotations.

A further object of the present invention is to allow all aspects of web page annotation creation, retrieval, and display to be customized for a particular web resource.

These and other objectives are attained with a client server annotation system for, and a method of, managing annotations for Web pages. The preferred client server annotation system comprises an annotation server for storing annotations; a set of Web page profiles, each of the page profiles being associated with one of the Web pages; and a client system including a client computer system. The client computer system includes instructions to execute a method comprising accusing Web pages, sending requests to the annotation server, locating at least one Web page profile, and using the located Web page profile to retrieve or store annotation information, from or to the annotation server, about the Web page associated with the Web page profile.

The preferred method of managing annotations comprises the steps of a user navigating to a Web page, and searching for one or more Web page profiles that apply to said Web page. The method comprises the further steps of identifying at least one of said Web page profiles; and using at least said one identified Web page profile to retrieve or store annotation information, from or to an annotation server, about said Web page.

The preferred embodiment of the invention, described below in detail, provides a generalized profile mechanism to allow all aspects of web page annotation creation, retrieval, and display to be customized for a particular web resource. These profiles are understood by a user's web browser (or a plug-in to the user's web browser). The web browser provides reasonable default behaviors for annotation creation, retrieval, and display so that a particular profile may be as complex and verbose or simple and concise as desired.

For any given web page, the invention provides for the client software to locate zero or more profiles from a variety of sources. These profiles may be authored by the web page author, the annotation user, an annotation administrator, or a third party. The annotation client may choose either a single profile to be active for the entire web page or it may activate all of the located profiles at once.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 schematically illustrates a client-server annotation system that may be used to implement this invention.

FIG. 2 schematically represents a Web page profile that may be used in the practice of the present invention.

FIG. 3 depicts a sample implementation of the invention in use as it retrieves multiple profiles and activates one or more of them for a particular web site.

FIG. 4 shows the use of two profiles to customize how annotations are found for a particular web page.

FIG. 5 illustrates the use of two profiles to display annotations returned by an annotation server for a particular web page.

FIG. 6 depicts the use of profiles when an annotation is created.

### DETAILED DESCRIPTION OF THE PREFERRED EMBODIMENTS

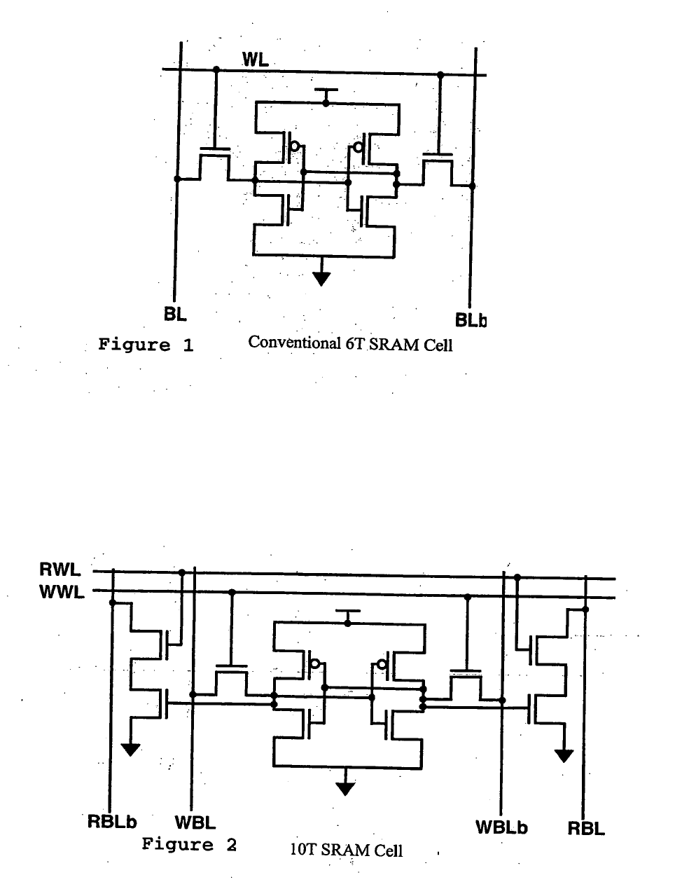

FIG. 1 illustrates a client-server annotation system 10 for managing annotations for Web pages, represented at 12. Generally, system 10 comprises annotation server 14, a set of Web page profiles 16, and a client system 20. Annotation server 14 is provided for storing annotations, represented at 22, and each Web page profile 16 is associated with one of the Web pages 12. As represented in FIG. 2, each Web page profile 16 holds information or data 24 used to retrieve or to store annotations 22 for the Web page associated with the Web page profile, and preferably the Web page profile also holds information 26 that may be used to display an annotation.

Client system 20 includes a client computer system that, in turn, includes instructions to execute a method comprising accessing Web pages, and sending requests to the annotation server. This method further comprises locating, as represented at 30, at least one Web page profile associated with an accessed Web page, and using, as represented at 32, the located Web page profile to retrieve or store annotation information, from or to the annotation server 14, about the Web page associated with the located Web page profile.

Preferably, the embodiment of the invention illustrated in FIG. 1 presupposes a client-server annotation system in which annotations are stored on the annotation server independent from the data being annotated. It also presupposes annotation client software integrated into a web browser that knows how to make annotation-related requests of an annotation server. IBM InsightLink—http://www-1.ibm.com/industries/healthcare/doc/content/solution/974118105.html—is an example of such a software system.

This invention adds new behavior to an annotation client in its interactions with an annotation server while viewing and annotating World Wide Web pages. The preferred implementation of the invention has two main components: the first component details how the annotation client locates and activates annotation profiles, and the second component details how the annotation client and profiles (and profile authors, therefore) collaborate to allow for accurate and useful annotation of web pages.

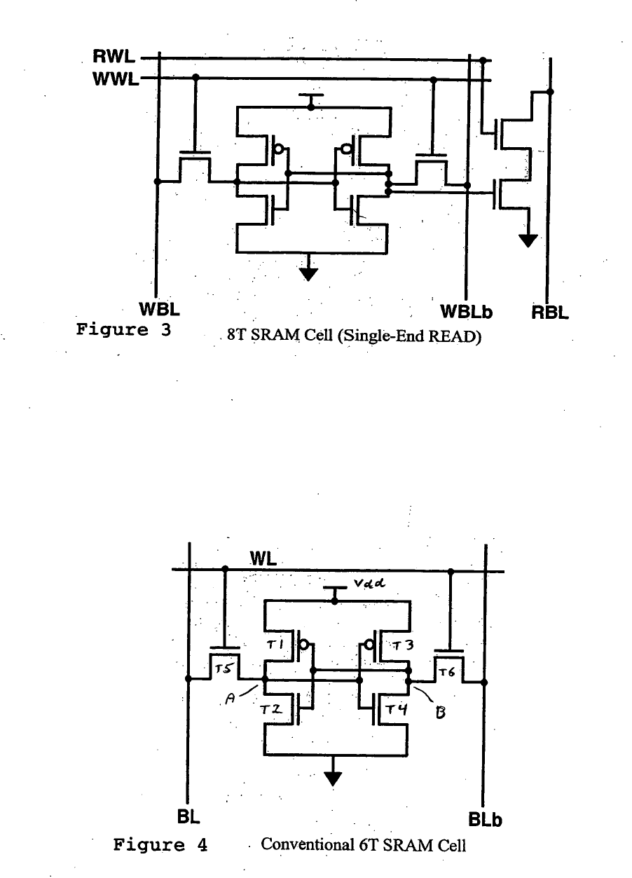

FIG. 3 depicts a sample implementation of the invention in use as it retrieves multiple profiles and activates one or more of them for a particular web site to which the user has navigated. An annotation client that incorporates this invention can check multiple sources for a profile for a particular web page. Of the sources that return profiles, the invention activates the first profile that wishes to be exclusive, or else activates all the profiles if none desire exclusivity.

More specifically, the preferred operation of the invention begins, as represented at step 52, when a user navigates to a web page using an annotation-enabled web browser, as represented at 54. To correctly and completely retrieve annotations for this web page, the system first searches for web-page annotation profiles that apply to the web page. These profiles may be located in a variety of places. First, at 56, the system looks inside the contents of the web page itself for a profile encoded as an XML data island within the web page's HTML source. Next, at 60, the system looks in a well-known location on the originating web server for a profile, potentially supplying the actual URL as an argument. For example, if the web page requested was http://www.ibm.com/help/support.html, then the system makes an HTTP request to http://www.ibm.com/annotation-profile?/help/support.html. If the web server supports site-wide profiles of this sort, then it returns to the client system the XML representation of the profile.

The annotation client then, at 62 and 64, queries the annotation server for profiles for this web page in two manners: user-specific and system-wide. The client supplies the server with the URL of the web page. The server looks in its database to determine if the user has stored any profiles for this web site, and also looks to see if an administrator has defined any profiles for this site. If any profiles are found, they are returned to the annotation client.

Finally, the annotation client, at 66, looks in the local workstation's registry for a profile applicable to this URL. (It is worth noting that in both this check and in the searches on the annotation server and originating web server, any heuristic may be employed to determine if a profile is appropriate for the URL specified. For example, profiles may be keyed with a regular expression against which the URL is matched. More complicated algorithms are also possible.)

At this point, the annotation client, as represented at 70, has discovered zero or more profiles—in the form of XML documents, perhaps—for the web page to which the user navigated. The client software parses and interprets these profile documents into a functional fashion so that it can query the attributes and abilities of each profile. The annotation client then looks at each profile in a user-defined order according to the source of each profile, asking, as represented at 72, if each profile wishes to be exclusive. A profile might demand to be exclusive if it knows that it does not interact well with other profiles. If a profile does demand exclusivity, then, as represented at 74, the system only activates that profile. Otherwise, all of the profiles that were returned to the client are activated. (If zero profiles were returned then the annotation system uses all of its default behaviors, acting as it would if the invention were not present at all.)

The second component of the preferred implementation of the invention concerns the use of the profiles and their interaction with default behaviors provided by the annotation client software. This interaction comprises three main areas of functionality: annotation retrieval, annotation display, and annotation creation. FIGS. 3-5 show example implementations of these three aspects of the invention.

FIG. 4 depicts the use of two profiles, represented at 80, to customize how annotations are found for a particular web page. The invention preferably allows for a profile to specify particular search criteria. As represented at 82, the annotation client can use these criteria to query an annotation server for annotations to be displayed on the web page. The client can either combine the criteria specified by the active profiles in a single search request, as represented at 84 or can issue one search request per profile, as represented at 86. FIG. 3 also depicts, at 90, the annotation client using a default search criteria when a profile does not specify this information.

As mentioned above, the representation of a profile is an implementation-specific detail, and may be XML or some other format. Profiles should preferably have the capability of containing arbitrary algorithmic logic, however, such that all of the properties and methods described herein that a profile may supply may be backed by and conditioned on arbitrary execution and evaluation of software code. The annotation client software supplies each activated profile with a reference to the in-memory representation of the current web page, in order that the profile can examine the web page as necessary. Similarly, the annotation client software supplies each activated profile with a reference to itself, allowing the profiles to invoke annotation requests such as a request to create a new annotation from the user interface elements that the profile adds to the Web page.

When the Web page has been fully loaded and rendered, the annotation client system queries the annotation server for annotations, as represented at 92. Using the invention, the profiles may elect to specify how annotations for this web page should be located on the annotation server. For example, one profile may request that annotations be located by the URL of the visiting web page, while another profile finds annotations by an application-specific identifier, such as the item identifier of an auction web page. If a profile does not specify search criteria, the annotation client requests annotations from the server according to a default search criterion. One possible default search criterion is the MD5 hash checksum value of the contents of the Web page.

This invention covers two possible methods for how the annotation client can request annotations from the server. In one of these methods, the client takes all of the search criteria provided by the profiles and sends their collective disjunction to the server in a single request. Each profile is given the opportunity to display each annotation returned from this search. In the other, preferred method, the annotation client issues one annotation search request to the server for each criteria set specified by a profile. In this case, each annotation returned is matched up with the profile that provided the criteria that found it, and a profile is only responsible for displaying the annotations that its search criteria locates.

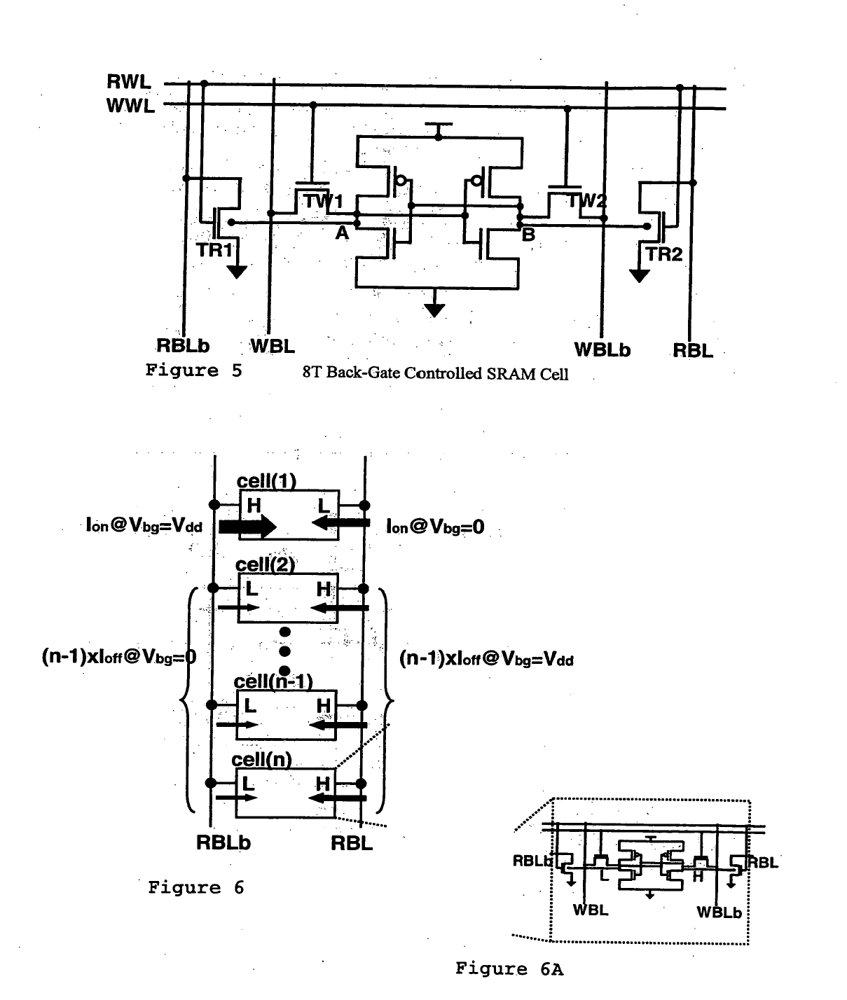

FIG. 5 depicts the use of two profiles to properly display annotations returned by the annotation server for a particular web page. Profiles can be responsible for the custom display of new annotations or annotations retrieved from the server. Annotations returned from a particular search can be correlated with and displayed by the profile that triggered that search, or every profile can be given an opportunity to draw every annotation retrieved from the server.

More specifically, as per the preceding, and a represented at 94, for every annotation returned by the server, the annotation client software asks the appropriate profile or profiles to display the annotation on the web page, as represented at 96. The profile can then decide how to show the annotation to the user. For example, one profile 102 might indicate an annotation by adding the image of a paperclip, as represented at 104, at the appropriate place in the web page (where the annotation was created), while another profile 106 might draw a yellow highlight, as represented at 110, on the text that was selected when the annotation was created. A third example profile might simply list all of the web page's annotation in a designated area of the web page. Because the invention supplies the active profiles with a reference to the loaded web page, the profiles can have arbitrary logic that allows them to dynamically alter the appearance of the Web page.

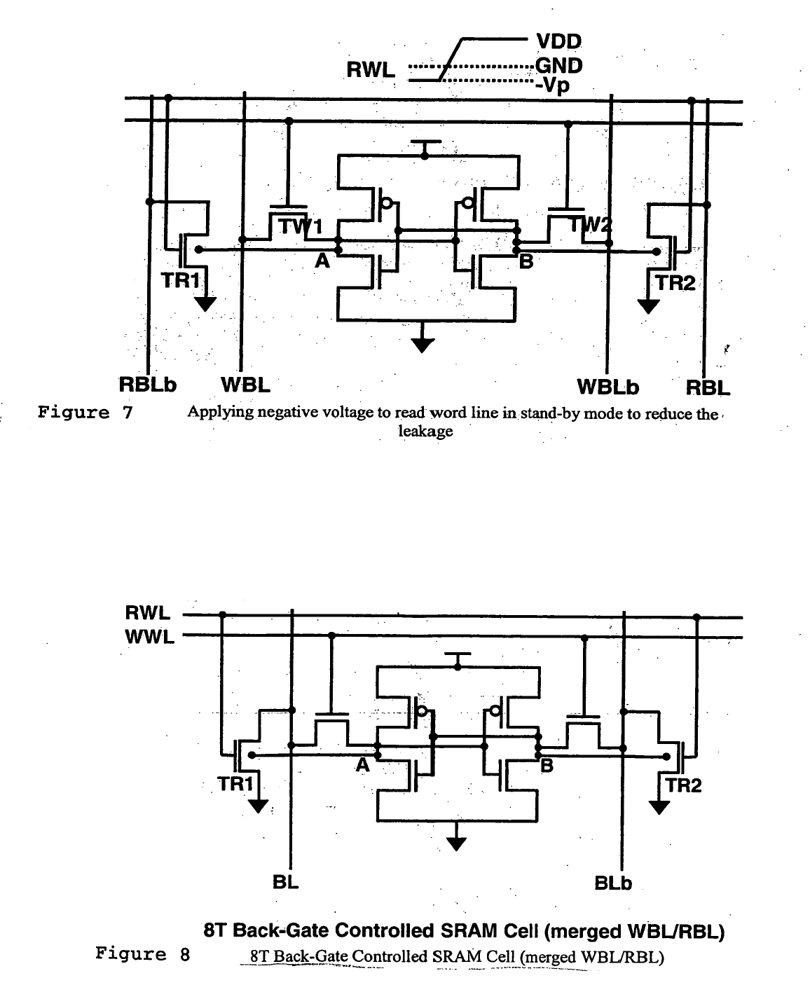

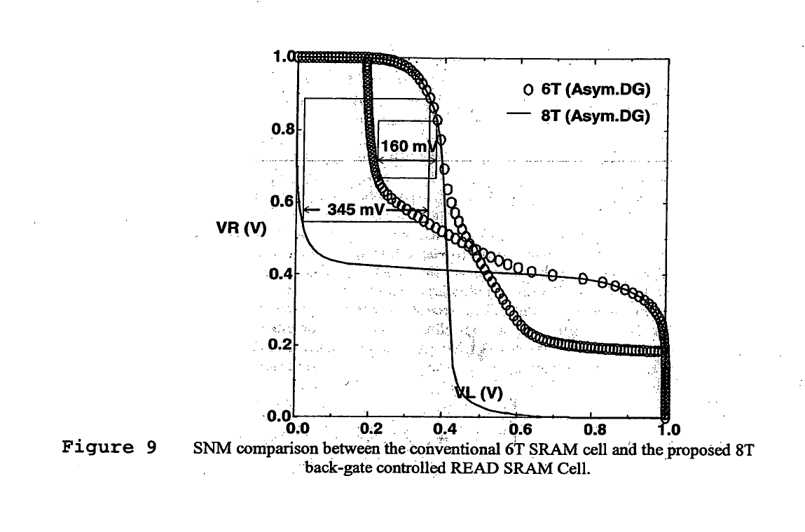

FIG. 6 depicts the use of profiles when an annotation is created. The invention, as represented at 112, provides for the annotation client to query each profile active on the current web page to find out if the web page is in a state in which the profile recognizes a user-specified target of a new annotation. This decision can incorporate elements such as the state of user-interface elements on the page (checkboxes, toggles, text selections, input boxes, etc.) or the location of the user-interface action that triggered the create-annotation action. The annotation client passes the target information, obtained at 114, from a profile (or default target information) onto the annotation server, represented at 116, in order that the new annotation is associated with the proper location in the Web page.

More specifically, when the user asks to create a new annotation, the annotation client system uses the profiles to determine what target information to associate with this new annotation on the annotation server. If the request to create a new annotation is initiated by a user-interface element added to the web page by a particular profile, then the system queries that profile only for the appropriate target information. Otherwise, if the new annotation request is triggered by user-interface elements provided by the annotation client software itself, then the system must ask each profile whether it recognizes the current state of the web page as having a selected annotation target. For example, a profile that allows annotating auction items returned in a search might add checkboxes next to each item. Such a profile would return the proper item identifier if an item is checked when the user elects to create a new annotation. If more than one profile believes it knows the proper target of the new annotation, then the system may prompt the user to discover which target information is correct. Once the system finds a profile that gives target information for the new annotation, the annotation client software submits a request, as represented at 120, to create a new annotation to the annotation server and includes the profile-supplied target information in this request.

Implementations of this invention may allow profiles to specify additional properties. For example, to facilitate sorting of all annotations on a web page for navigational purposes, the annotation client software may ask profiles to specify where within the web page an annotation found by that profile is, using any suitable globally comparable coordinate system.

It should be noted that many alternative or additional features may be used in the practice of this invention. For example, in one alternative embodiment to the automated search for the proper profile to use for the current web page described above, the annotation system presents the user with a list of all possible profiles for the web page, and the user may choose which profile to use. Additionally, the system might show the user the profiles along with the annotations created with each of those profiles to help facilitate this choice.

In a second alternative embodiment, the annotation system stores along with an annotation a pointer to the profile that was active when the annotation was created. Later, when a different user retrieves the annotation, the annotation system can display the annotation properly by following the pointer to the profile, even if this second user would not normally have had that profile active.

As indicated hereinabove, it should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

What is claimed is:

1. A client-server annotation system for managing annotations for Web pages, the annotation system comprising:
an annotation server for storing annotations;
a set of Web page profiles, each of the page profiles being associated with one of the Web pages;
a client system including a client computer system, wherein the client computer system includes instructions to execute a method comprising:
accessing Web pages, and
sending requests to the annotation server,
locating at least one Web page profile, and
using the located Web page profile to retrieve or store annotation information, from or to the annotation server, about the Web page associated with the Web page profile.

2. A client server annotation system according to claim 1, wherein each profile specifies at least one search criteria to retrieve or store annotations from or in the annotation server for the Web page associated with the profile.

3. A client server annotation system according to claim 2, wherein the step of using the located Web page profile includes using said search criteria to retrieve or store annotations from or in the annotation server.

4. A client server annotation system according to claim 2, wherein:
the step of locating at least one Web page profile includes locating a plurality of Web page profiles associated with a specific one of the Web pages; and
the step of using the located Web page profile includes combining the search criteria of said plurality of Web page profiles into a single search request, and using said search request to retrieve or store annotations from or in the annotation server for said specific one of the Web page.

5. A client server annotations system according to claim 1, wherein each of the Web page profiles includes instructions for displaying annotations on the Web page associated with the Web page profile.

6. A client server according to claim 1, wherein:
each of the Web page profiles identifies at least one state of the Web page associated with the Web page profile; and
the method executed by the client computer system further includes
creating new annotations for the Web pages, and
acting, when a new annotation is created at a given time for a given one of the Web pages, to check the state of the given Web page at said given time, and to search for a Web page profile that identifies the state of the given Web page at said given time.

7. A method of managing annotations for Web pages, comprising the steps of:
a user navigating to a Web page;
searching for one or more Web page profiles that apply to said Web page;
identifying at least one of said Web page profiles; and
using at least said one identified Web page profile to retrieve or store annotation information from or to an annotation sever, about said Web page.

8. A method according to claim 7, wherein the step of identifying at least one Web page profile includes the steps of:
initially finding a plurality of Web page profiles that apply to said Web page; and
activating one of said plurality of Web page profiles.

9. A method according to claim 8, wherein the using step includes the step of using the activated Web page profile to retrieve or store annotation information from or to the annotation server.

10. A method according to claim 7, wherein:
the step of identifying at least one Web page profile includes the step of initially finding a plurality of Web page profiles that apply to said Web page; and
the using step includes the step of using said plurality of Web page profiles to retrieve or store annotation information from or to the annotation sever.

11. A method according to claim 7, wherein:
the navigating step includes the step of forming in a client system an in memory representation of the Web page; and
the using step includes the step of providing said at least one of the identified Web page profiles with a reference to said in memory representation.

12. A method according to claim 11, wherein the using step further includes the step of providing said at least one of the identified Web page profiles with a reference to itself to enable said at least one profile to invoke annotation requests.

13. A method according to claim 7, wherein the Web page profiles are located in one or more of the group of locations consisting of:
in the Web pages,
on a Web server,
on the annotation server, and
on the client system.

14. A program storage device readable by machine, tangibly embodying a program of instructions executable by the machine to perform method steps for managing annotations for Web pages, said method steps comprising:
navigating to a Web page;
searching for one or more Web page profiles that apply to said Web page;
identifying at least one of said Web page profiles; and
using at least said one identified Web page profile to retrieve or store annotation information from or to an annotation sever, about said Web page.

15. A program storage device according to claim 14, wherein:
the step of identifying at least one Web page profile includes the steps of
i) initially finding a plurality of Web page profiles that apply to said Web page, and
ii) activating an exclusive one of said plurality of Web page profiles; and
the using step includes the step of using the activated Web page profile to retrieve or store information from or to the annotation server.

16. A program storage device according to claim 15, wherein the activating step includes the step of looking at the plurality of Web page profiles to determine which one of said profiles to activate.

17. A program storage device according to claim 15, wherein the step of identifying at least one Web page profile includes the steps of:
initially finding a plurality of Web pages that apply to said Web pages,
presenting a list of said plurality of Web page profiles to a user, and
enabling the user to activate one or more of the plurality of Web page profiles.

18. A program storage device according to claim 14, wherein the searching step includes the steps of:
storing pointers that point to profiles that apply to the Web page; and
using the pointers to find the one or more profiles that apply to the Web page.
